(19) United States
(12) Patent Application Publication
(10) Pub. No.: US 2013/0341316 A1
(43) Pub. Date: Dec. 26, 2013

(54) FREE STANDING ELECTRIC AIR DRYER

(71) Applicant: Gonzalo Perez, Fort Lauderdale, FL (US)

(72) Inventors: Gonzalo Perez, Fort Lauderdale, FL (US); Don Salerno, Hollywood, FL (US)

(21) Appl. No.: 13/920,363

(22) Filed: Jun. 18, 2013

Related U.S. Application Data
(60) Provisional application No. 61/690,162, filed on Jun. 21, 2012.

(51) Int. Cl. F26B 23/06

(52) U.S. Cl. CPC F26B 23/06
USPC 219/220; 392/382; 219/482

(57) ABSTRACT

A free standing air blower for providing directed ventilation includes an air duct, a blower, a heating element, a deflector and a base unit. The deflector is disposed on an end of the air duct and has an angle of deflection configured to deflect air from the air duct to an area laterally adjacent to the drier.

### CROSS-REFERENCE TO RELATED APPLICATION

The present invention is related to and claims priority to U.S. Provisional Patent Application No. 61/690,162, entitled “GuyDry—Electric air dryer free standing tower for drying of pubic region, groinal and crotch areas,” filed Jun. 21, 2012, the entire contents of which is incorporated herein by reference.

### TECHNICAL FIELD

Ventilation and personal hygiene, and in particular, to a free standing apparatus for providing directed ventilation.

### BACKGROUND

Blower mechanisms and driers are generally known in the art and may be used for a number applications including drying areas of a user's body after bathing, drying hair after hair cuts or styling and drying skin or nails after application of make-up.

Conventional blower mechanisms and driers require that a user manually manipulates and/or positions the blower to direct the air to a desired region of the body for drying. Other conventional blower mechanisms do not specifically direct the blown air to particular body regions, but instead, provide diffused air to a user's body or particular region. The manual manipulation and positioning of the blower mechanism and the diffused air can make drying areas of the body, e.g., the lower torso, tedious and difficult to effectively dry.

Therefore, in view of the different blower mechanisms discussed above, it is desirable to have a blower mechanism that addresses these shortcomings.

### SUMMARY

The present invention provides an air drier. The air drier includes an air duct, a blower, a heating element, a deflector and a base unit. The air duct has a first end and a second end, the second end being opposite and subjacent to the first end of the air duct. The air duct has a length that is a distance between the first end and the second end. The blower is disposed at the second end of the air duct and configured to propel air along the length of the air duct. The heating element is disposed between the first end of the air duct and the blower. The deflector is disposed on the first end of the air duct and has an angle of deflection. The angle of deflection is configured to deflect air from the air duct to an area laterally adjacent to the drier. The base unit has a first end and a second end. The second end of the base unit is opposite and subjacent to the first end of the base unit. The second end is disposed on the first end of the base unit and is wider than the first end of the base unit.

In accordance with another aspect, a free standing upright drier is provided. The free standing upright drier includes a first unit having a base portion and an end portion, wherein the base portion is wider than the end portion, and the base portion includes a first edge and a second edge opposite the first edge. The first unit is configured to increase in width from the end portion along a length of the first unit to the base portion. The drier further includes a second unit, wherein the second unit defines a passage between a first end of the second unit and a second end of the second unit, the second end being opposite the first end. The first end of the second unit has a width substantially identical to a width of the end portion of the first unit. The first end of the second unit is coupled to the end portion of the first unit. The drier further includes a third unit, wherein the third unit has a first end and a second end, the second end being opposite the first end. The first end of the third unit has a width substantially identical to a width of the second end of the second unit. The first end of the third unit is coupled to the second end of the second unit. The drier further includes a support member that is disposed on a portion of the first unit, a portion of the second unit and a portion of the third unit. The support member is configured to provide rigidity to the second unit, to join the first unit and the second unit, and to join the second unit and the third unit. The drier further includes a first and a second foot member, wherein the first and second foot members being disposed on the first edge and the second edge of the base portion, respectively. The base portion defines an intake vent, and the second end of the third unit defines an outlet vent, and the outlet vent includes a deflector. The drier further includes a blower disposed in the first unit, wherein the blower is configured to propel a fluid from the intake vent and discharge the fluid at the end portion of the first unit. The drier further includes a heater disposed in the second unit. The heater is configured to heat the fluid that enters the first end of the second unit and traverses a portion of a length of the second unit before the fluid is discharged at the second end of the second unit. The drier further includes a light disposed on the first unit, wherein the light is configured to illuminate a portion of the base portion if the upright drier is connected to a power source. The drier further includes a heater control disposed on the first unit, wherein the heater control includes a first setting and a second setting. The drier further includes a blower control disposed on the first unit, wherein the blower control includes a first setting and a second setting. The drier further includes a user control disposed at the base portion of the first unit, wherein the user control is configured to activate the blower and the heater based on a setting of the blower control and a setting of the heater control, respectively. The user control includes a timer configured to deactivate the blower and the heater after a length of time. The drier further includes a safety switch disposed in the first unit, wherein the safety switch is configured to interrupt a power to at least one of the upright drier, the heater and the blower if a tilt angle of the upright drier exceeds a threshold value. The drier further includes a cancel switch disposed on the second unit, wherein the cancel switch is configured to deactivate the blower and the heater when selected.

In accordance with another aspect, a controller for controlling an air drier having a blower a heating element and a deflector includes a blower controller, a heater controller and a deflector controller. The blower controller controls a blowing speed of the blower. The heater controller controls a temperature of the heating element. The deflector controller controls an angle of deflection of the deflector. The blower controller and the heater controller are configured to vary the blowing speed and the temperature based on the angle of deflection of the deflector.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary drier constructed in accordance with the principles of the present invention;

FIGS. 2a-d are front, right side, left side and rear perspective views of an exemplary drier constructed in accordance with the principles of the present invention;

FIG. 3 is a top plan view of an exemplary drier constructed in accordance with the principles of the present invention;

FIG. 4 is a bottom view of an exemplary drier constructed in accordance with the principles of the present invention;

FIG. 5 is an exploded perspective view of an exemplary drier constructed in accordance with principles of the present invention;

FIG. 6 is a partial exploded perspective view of an exemplary drier constructed in accordance with principles of the present invention;

FIG. 7 is an exemplary controller for operating a drier constructed in accordance with principles of the present invention; and

FIG. 8 is an illustration of the drier in use in accordance with principles of the present invention.

### DETAILED DESCRIPTION

Before describing in detail exemplary embodiments that are in accordance with the present invention, it is noted that the embodiments reside primarily in combinations of apparatus components relating to providing directed ventilation. The present invention is a free standing electric air drier that directs air to a desired part of a user's body.

Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

The present disclosure will be understood more fully from the detailed description given below and from the accompanying drawings of particular embodiments of the invention which, however, should not be taken to limit the invention to a specific embodiment but are for explanatory purposes.

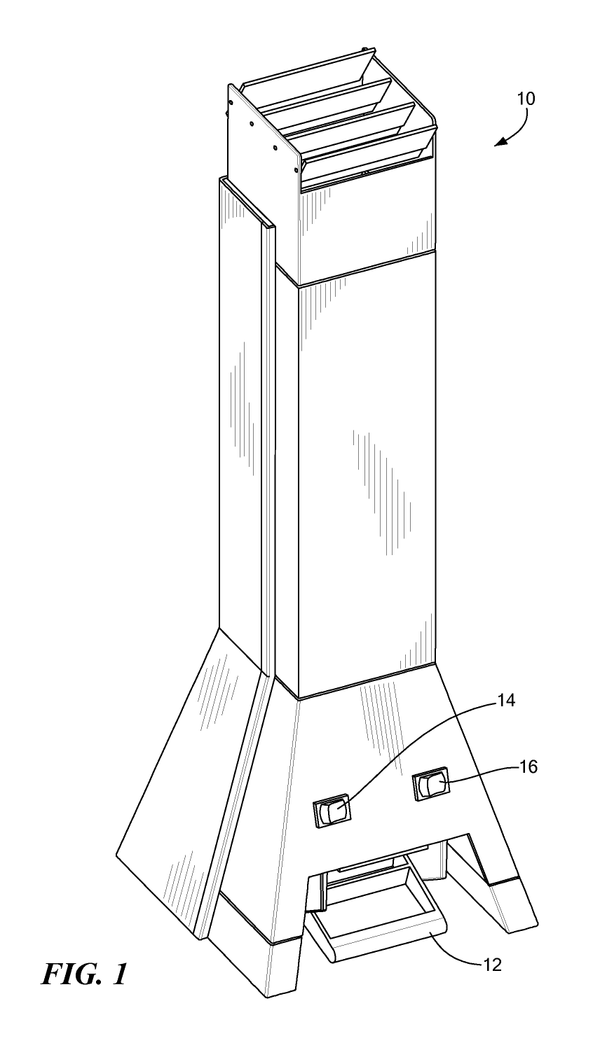

Referring now to the drawing figures, in which like reference designators denote like elements, there is shown in FIG. 1 an air drier 10 for providing directed ventilation. The air drier 10 includes one or more controls such as a start selector 12, a blower speed selector 14, a heat selector 16 and a cancel actuator 18. The start selector 12 is a user operated control that may be a toggle switch or a momentary switch, for example, that may be operated by a user's foot. The start selector 12 actuates the air drier 10 when selected. The blower speed selector 14 may be a user operated rocker switch having two or more positions corresponding to two or more blower speeds. The blower speeds may be, for example, low, medium and high, which correspond to progressively increasing air speeds.

Similar to the blower speed selector 14, the heat selector 16 may be a user operated rocker switch having two or more positions corresponding to two or more heat settings. The heat settings may be, for example, low and high, which correspond to progressively increasing air temperatures.

According to other exemplary embodiments, the blower speed selector 14 and the heat selector 16 may be continuously variable selector knobs or slides, for example, that vary the blower speed and heat, respectively, over a continuous range.

The cancel actuator 18 may be a user operated momentary switch. When selected, the cancel actuator 18 may turn off the air drier 10. According to other exemplary embodiments, the cancel actuator may stop power to all components of the air drier 10. According to still other exemplary embodiments, the cancel actuator may be combined with the start selector 12, for example, as a combined start selector 12/cancel actuator 18 such that during operation, a first selection of the combined start selector 12/cancel actuator 18 actuates the air drier 10 and a second selection of the combined start selector 12/cancel actuator 18 turns off the air drier 10.

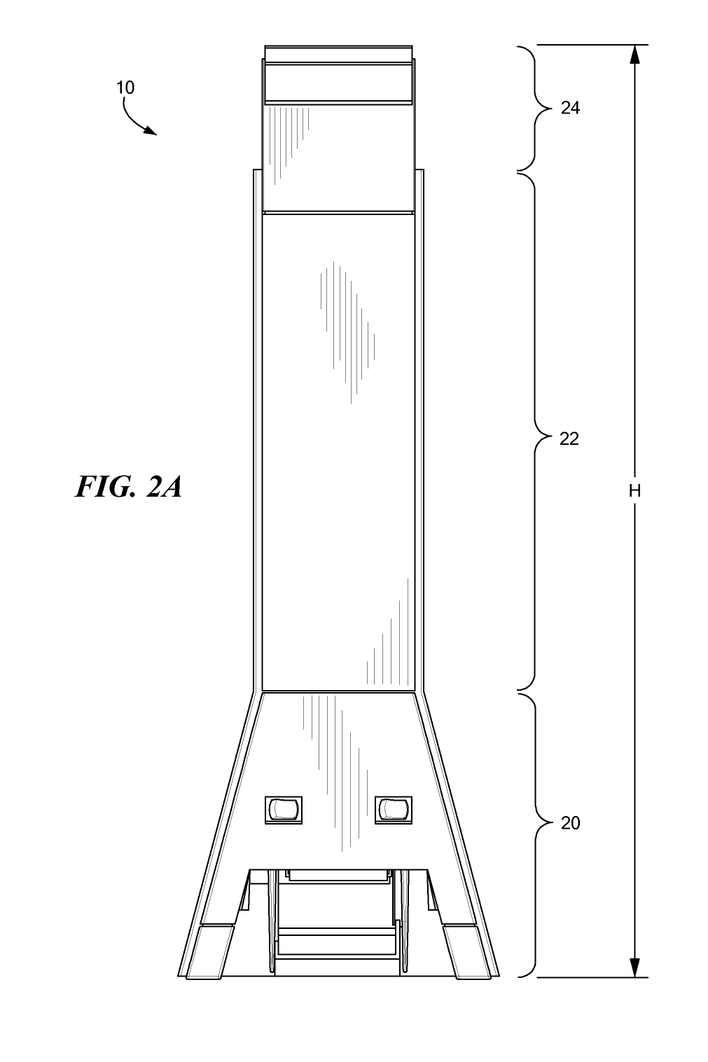

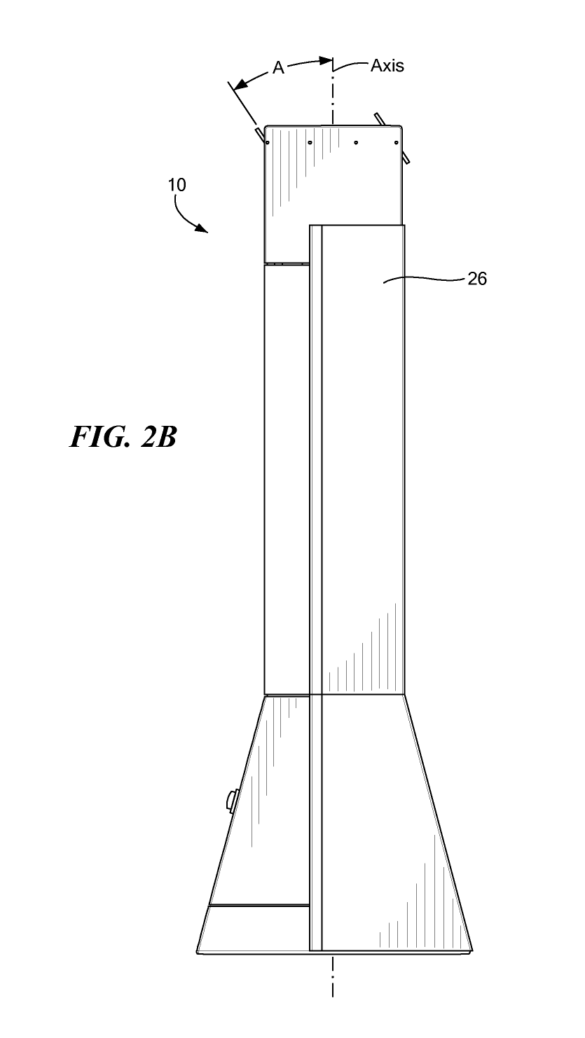

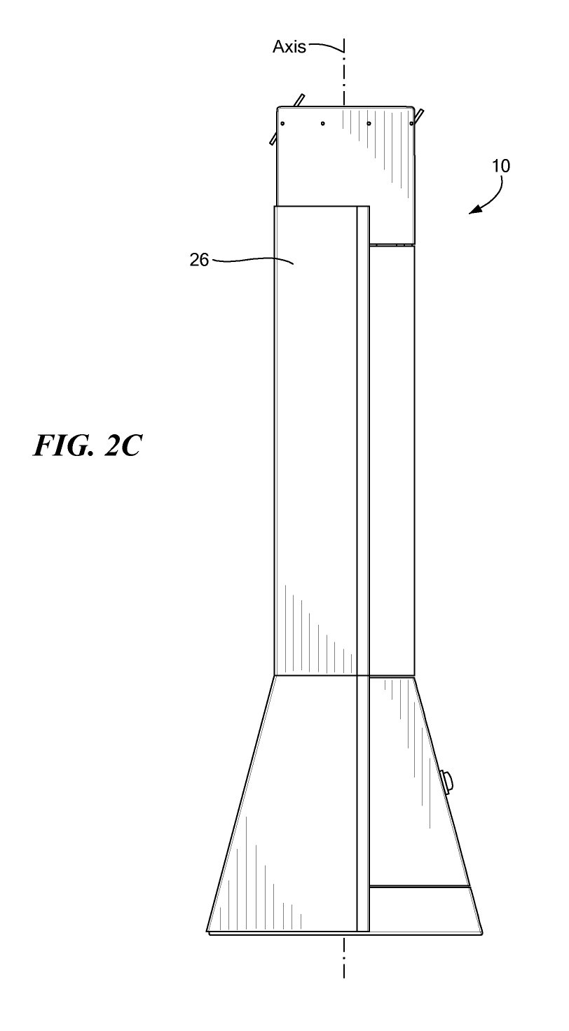

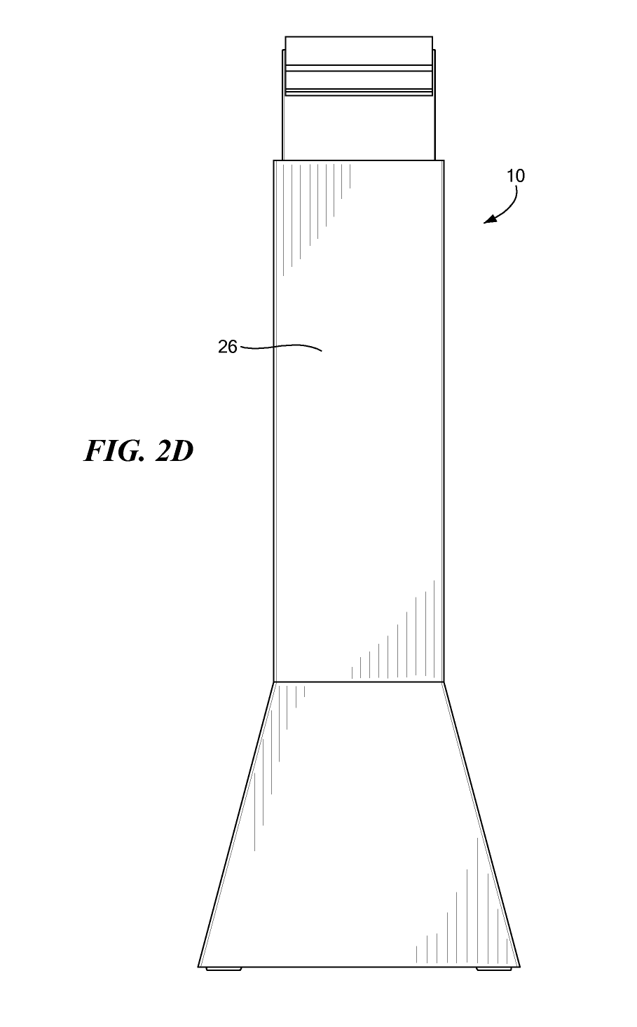

As shown in FIG. 2a, the air drier 10 is generally comprised of a first unit section 20 that is attached to a second unit section 22 that is attached to a third unit section 24.

The first unit section 20 may be a base portion of the air drier 10. The first unit section 20 has a rectangular cross section at a medial end of the first unit section 20 where the first unit section 20 meets the second unit section 22 and flares to a wider dimension at a distal end of the first unit section 20. The second unit section 22 has a rectangular cross section that is substantially the same from the point where the second unit section 22 meets the first unit section 20 to the point where the second unit section 22 meets the third unit section 24. The third unit section 24 has a rectangular cross section that is substantially the same from a medial portion where the third unit section 24 meets the second unit section 22 to a distal portion of the third unit section.

According to some exemplary embodiments, a height H of the air drier 10, which is defined by the height of the combined first, second and third unit sections 20, 22 and 24 may be substantially between about sixteen (16) inches and about twenty-four (24) inches.

According to some exemplary embodiments, the distal end of the first unit section 20 may have a square cross section that is five (5) inches wide and five (5) inches high. The third unit section 24 may have a rectangular cross section that is four (4) inches wide and two (2) inches high.

According to other exemplary embodiments, the cross section of the first, second and third unit sections 20, 22 and 24 may be square, trapezoidal, circular, elliptical or oval.

As shown in FIGS. 2b-d, the air drier 10 includes a support member 26 on a back side of the air drier 10. The support member 26 connects the first, second and third unit sections and may provide structural support and rigidity to the air drier 10. The support member 26 wraps around a portion of the air drier 10 such that the support member 26 covers the back side of the air drier 10 and a portion of the right and left sides.

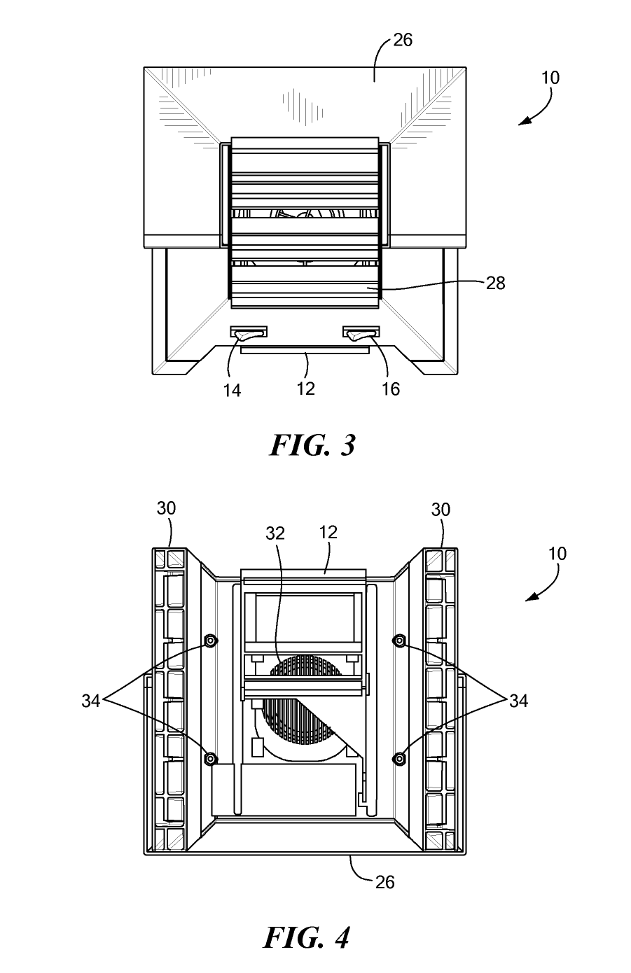

As shown in FIG. 3, the air drier 10 includes a deflector 28. The deflector 28 is comprised of one or more louvers or slats that are configured to be a width of the third unit section 24 between left and ride sides thereof. Each of the louvers may be at periodically spaced locations between front and back sides of the third unit section 24. Each of the louvers has an angle of deflection A, which is measured between an axis running the height H of the air drier 10 (see FIGS. 2b-c) and a plane of each of the louvers. The angle of deflection A of the deflectors 28 is fixed between about twenty (20) degrees and about sixty (60) degrees. According to some exemplary embodiments, the angle of deflection A of the deflectors 28 may be fixed at forty-five (45) degrees.

According to some exemplary embodiments, the angle of deflection A of deflectors 28 may be adjustable between about zero (0) degrees and about eighty (80) degrees. According to some exemplary embodiments, the height H of the air drier 10 and the angle of deflection A of deflectors 28 may be adjusted or optimized such that the deflectors 28 target (by deflecting fluid flowing therethrough) a specific region of a user's body if the user stands next to, or laterally adjacent to the air drier 10. The deflectors 28 may be configure to target a groin region of a user, for example.

According to other exemplary embodiments, the deflectors 28 may be in a bezel (not shown) that may rotate in a plane perpendicular to the axis running the height H of the air drier 10. According to still other exemplary embodiments, the angle of deflection A of the deflectors 28 may be actively adjusted such that the angle may vary, or oscillate, for example, between a first angle and a second angle.

As shown in FIG. 4, the air drier 10 includes feet 30 on left and right sides of a bottom side of the air drier 10. The feet 30 may be rectangular and have a length equal to about the depth (from front to back) of the drier 10 at a deepest section of the drier 10. The feet 30 may be a non-slip material that electrically insulates the drier 10 from a surface on which the drier 10 may be placed. The feet 30a and 30b may also isolate the drier 10 from vibration, shock or acoustic noise that may be transmitted from and/or to the surface on which the drier 10 is placed.

The air drier 10 includes an intake vent 32. The intake vent 32 is an aperture defined by a bottom of the drier that allows fluid interaction between an outside of the air drier 10 and an inside of the air drier 10. In other words, the intake vent 32 allows air to enter the air drier 10. The intake vent 32 includes a screen to prevent debris from entering the air drier 10.

According to some exemplary embodiments, the intake vent 32 may include a filter that prevents particulate debris, e.g., airborne debris including dust and hair, from entering the air drier 10. The filter may be washable or replaceable.

The air drier 10 includes lighting elements 34 on the bottom side of the air drier 10. The lighting elements 34 illuminate a bottom region of the air drier 10 around the start selector 12. The lights 34 also provide general illumination when the air drier 10 is powered. The lighting elements 34 may include an incandescent source and/or a light emitting diode (LED), for example.

According to some exemplary embodiments, the lighting elements 34 may provide temporary emergency lighting due to loss of power. According to other exemplary embodiments, the lighting elements 34 may include multi-colored lights whose color may vary depending on different conditions. According to one exemplary embodiment, a temperature of the air and/or a setting of the heat selector 16. For example, a blue, or blue-tone color may be used to indicate a lower (relatively cooler) setting of the heat selector 16 and a red, or red-tone color may be used to indicate a higher (relatively hotter) setting of the heat selector 16. According to another exemplary embodiment, the lighting elements 34 may indicate a status of the power available to the air drier 10. For example, a first color may be exhibited when normal power from an outlet connected to the air drier 10 is available and a second color may be exhibited when the outlet power is not available. In still other exemplary embodiments, a third color may be exhibited when the outlet is improperly grounded. Although multi-colored lighting elements 34 are described herein, the lighting elements 34 may also be configured to flash on/off at different rates or at different intervals to indicate the different conditions described herein. Although four lighting elements 34 are illustrated, one having ordinary skill in the art will appreciate that the air drier 10 may include more or fewer lights.

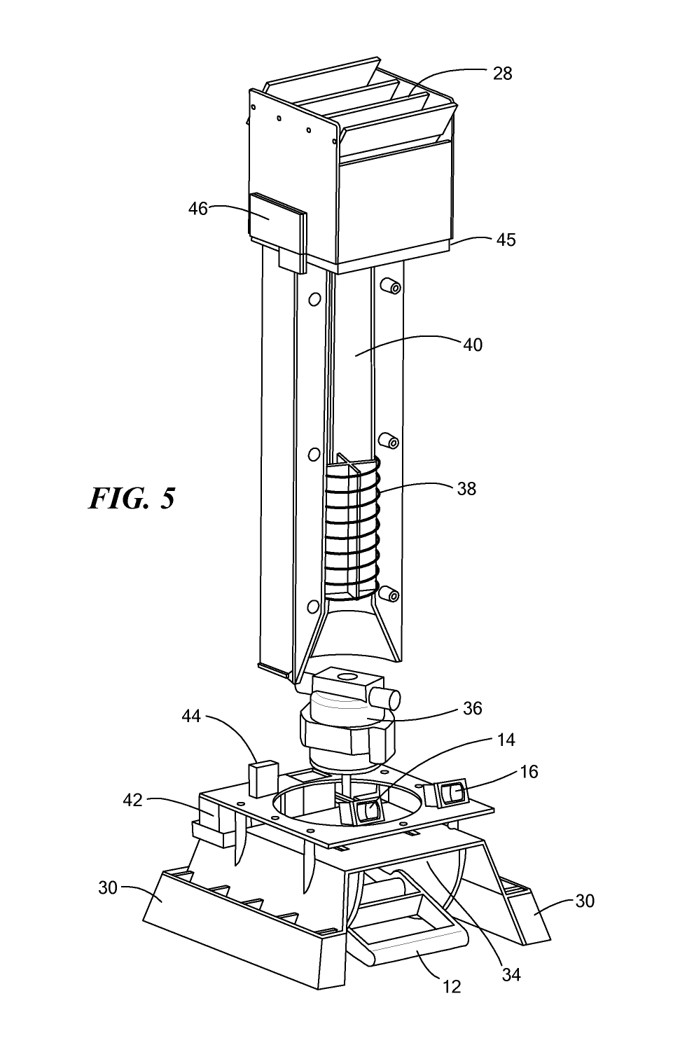

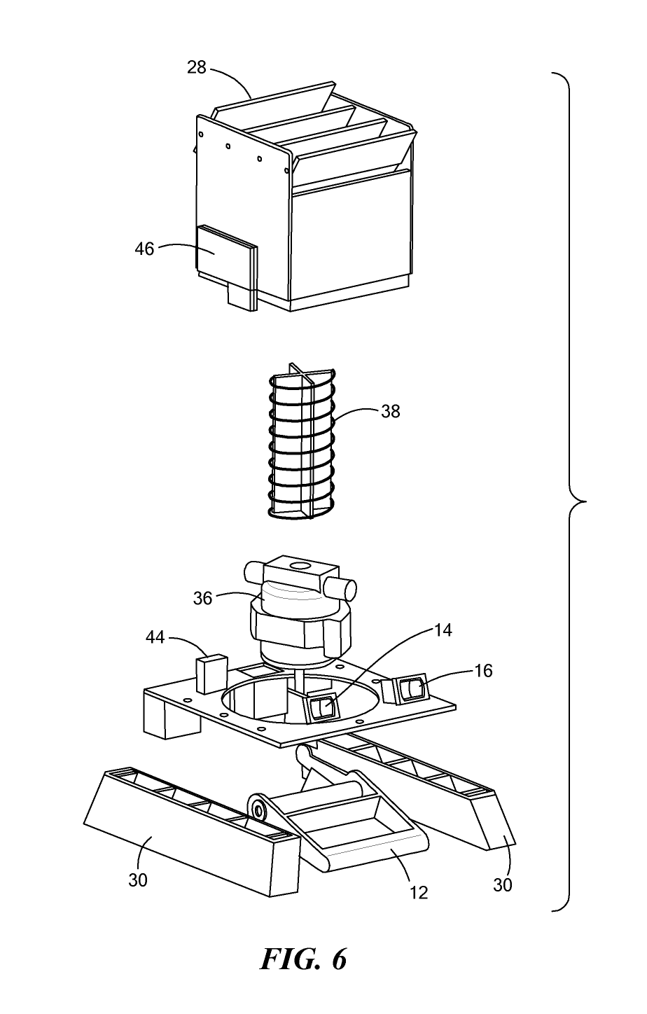

As shown in FIGS. 5 and 6, the air drier 10 includes apparatus within the first and second unit sections 20 and 22. The apparatus include a blower assembly 36 for moving a fluid such as air through the air drier 10. The blower assembly 36 draws air in through the intake vent 32 and sends air through an air duct 40 to a heating assembly 38, which is disposed at or round the outlet of the blower assembly 36. The heating assembly 38 heats the air sent through the air duct 40 as the air passes over heating elements of the heating assembly 38. The air duct 40 directs the air that is sent from the blower assembly 36 and heated by the heating assembly 38 to the deflector 28, which deflects the air to an area adjacent to the air drier 10 based on the angle of deflection A of the deflector 28.

According to some exemplary embodiments, the blower assembly 36 includes a fan configured to operate at multiple speeds including at least a first speed and a second speed, wherein the first speed is greater than a second speed. According to some exemplary embodiments, the blower assembly 36 may move air between ten (10) and twenty-seven (27) meters per second. The speed of the blower assembly 36 is controlled by the blower speed selector 14.

According to some exemplary embodiments, the heating assembly 38 is a multi-setting device that may have at least a first heat setting and a second heat setting, wherein the first heat setting is greater than a second heat setting. According to some exemplary embodiments, the heating assembly 38 may include a resistive heating element, which may be a wire or ribbon that may be straight or coiled to heat the air to between about one hundred (100) to about one hundred and fifty (150) degrees, for example. The heat setting of the heating assembly 38 is controlled by the heat selector 16.

According to some exemplary embodiments, a drip catch 45 may be between the deflector 28 and the heating assembly 38. The drip catch 45 intercepts or catches any drops of water or any debris that falls through the deflector 28 so that the water or debris does not contact the heating assembly 38 and/or the blower assembly 36, potentially causing damage to one or both assemblies. The drip catch 45 may include a removable drip tray (not shown) that collects any caught water or debris.

The air drier 10 includes a safety switch 42 that interrupts power to the air drier 10 when the safety switch 42 detects that the air drier 10 is at an angle relative to the axis running the height H of the air drier 10 beyond a threshold value. In other words, the safety switch 42 detects when the air drier 10 has tipped over or may tip over.

According to some exemplary embodiments, the safety switch 42 may include a momentary switch located at a bottom of the air drier 10 that detects whether the air drier 10 has been placed on a flat surface.

The air drier 10 includes a cancel timer switch 44, which turns the blower assembly 36 and/or the heating assembly 38 off after the blower assembly 36 and/or the heating assembly 38 have been on for a preset time. The cancel timer switch 44 is also activated by the user when the user selects the cancel actuator 18, which may be in electrical or mechanical communication with the cancel timer switch 44.

The air drier 10 includes a controller 46 for controlling an operation of the drier 10. The controller 46 is a logical component that controls the deflection angle A of the deflector 28, the speed of the blower assembly 36, the temperature of the heating assembly 38 and the lighting elements 34.

According to some exemplary embodiments, the air drier 10 may include a proximity sensor (not shown), at the deflector 28. The proximity sensor may determine a distance to an item or surface and may be in communication with the safety switch 42 to interrupt power, which may be protected by, for example, a Ground Fault Current Interrupter, to the air drier 10 if the proximity sensor determines that the distances to the item or surface is less than a threshold value. The proximity sensor may, for example, protect against damaging or burning surfaces near the air deflector 28.

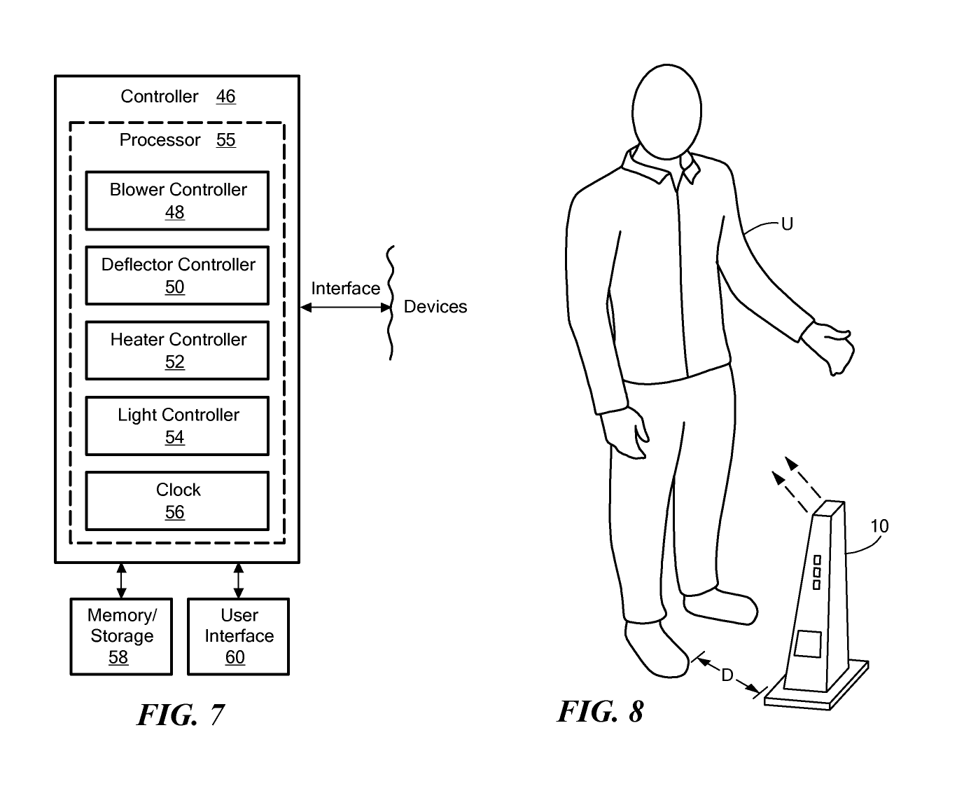

As shown in FIG. 7, the controller 46 for operating the air drier 10 includes a blower controller 48, a deflector controller 50, a heater controller 52 and a light controller 54. The blower controller 48 controls the blower assembly 36. The deflector controller 50 controls the angle of deflection A of deflector 28. The heater controller 52 controls the temperature of heating assembly 38. The light controller 54 controls the intensity (brightness) and/or color of lighting elements 34. The controller 46 may include a clock 56, which may enable the controller 46 to incorporate timing features in the control of any of the blower controller 48, the deflector controller 50, the heater controller 52 and the light controller 54. The controller 46 may include an interface for physically communicating with the controlled devices. The interface may include one or more individual ports or a general communication bus, for example.

According to some exemplary embodiments, a processor 55 may implement aspects of the controller 46. The controller 46 may communicate with a memory or storage 58 where user preferences may be stored, for example. The controller 46 may include a user interface 60 by which a user may interact with the controller 46 to set, view or change user preferences, for example.

As shown in FIG. 8, a user U is shown operating the air drier 10. During operation, the air drier 10 directs air (shown as dashed lines) to the user U who is standing adjacent to the air drier 10 and a distance D from the air drier 10. It should be appreciated that the air is directed to the user U based on the angle of deflection A of the deflectors 28. It should be appreciated that the distance D and the angle of deflection A may be adjusted to specifically dry desired regions of the user U's body. It should also be appreciated that because the user U is standing a distance D from the drier 10 and not standing directly over the air drier 10, water dripping off the user U does not drip onto or into the air drier 10. It should be further appreciated that because the air drier 10 operates on a timer (cancel timer 44) and the start selector 12 is foot-operated, the air drier 10 is operable hands-free, such that the user U is able to use his hands for other activities. The user U and the air drier 10 are not necessarily drawn to scale, and are shown merely for demonstration and perspective.

The present invention can be realized in hardware, or a combination of hardware and software. Any kind of computing system, or other apparatus adapted for carrying out the controller described herein, is suited to perform the functions described herein. A typical combination of hardware and software could be a specialized computer system, having one or more processing elements and a computer program stored on a storage medium that, when loaded and executed, controls the computer system such that it carries out the functions described herein. The present invention can also be embedded in a computer program product, which comprises all the features enabling the implementation of the functions described herein, and which, when loaded in a computing system is able to carry out these functions. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An air drier for providing directed ventilation, the drier comprising:
an air duct, the air duct having a first end and a second end, the second end of the air duct being opposite and subjacent to the first end of the air duct, the air duct having a length, the length being a distance between the first end and the second end;
a blower disposed at the second end of the air duct, the blower configured to propel air along the length of the air duct;
a heating element disposed between the first end of the air duct and the blower;
a deflector disposed on the first end of the air duct, the deflector having an angle of deflection, the angle of deflection configured to deflect air from the air duct to an area laterally adjacent to the drier; and
a base unit, the base unit having a first end and a second end, the second end of the base unit being opposite and subjacent to the first end of the base unit, the second end of the air duct disposed on the first end of the base unit, and the second end of the base unit being wider than the first end of the base unit.

2. The drier of claim 1, wherein the angle of deflection is between twenty (20) degrees and sixty (60) degrees.

3. The drier of claim 1, wherein the deflector oscillates such that an angle of deflection varies between twenty (20) degrees and sixty (60) degrees.

4. The drier of claim 1, further comprising:
a user control for activating the blower and the heating element, the user control being disposed at the second end of the base unit; and
a lighting element configured to illuminate the user control.

5. The drier of claim 1, further comprising:
a lighting element configured to illuminate a portion of the base unit; and
a power interface for connecting the drier to a power source, wherein:
the lighting element is configured to emit a first color and a second color, the first color being different than the second color; and
one of the first color and the second color is emitted based on at least one of a temperature setting of the heating element and a quality of the power source connected to the power interface.

6. The drier of claim 1, wherein a length of the drier is less than twenty-four (24) inches.

7. The drier of claim 1, wherein a speed of the blower varies based on the angle of deflection of the deflector.

8. The drier of claim 1, wherein a temperature of the heating element varies based on the angle of deflection of the deflector.

9. The drier of claim 1, further comprising:
a drip catch disposed superjacent to the heating element, the drip catch configured to catch condensation or debris that enters the drier past the deflector.

10. The drier of claim 1, further comprising:
a proximity sensor, the proximity sensor configured to determine a distance to an object, wherein the proximity sensor is configured to interrupt power to the heating element if the distance to the object is less than a predetermined threshold value.

11. A controller for operating a heated drier, the controller comprising:
a blower control module configured to control a blowing speed of a blower; and
a heater control module configured to control a temperature of a heating element.

12. The controller of claim 10, further comprising:
a deflector control module configured to control an angle of deflection of a deflector.

13. The controller of claim 11, wherein one of the blower control module and the heater control module is configured to vary the blowing speed of the blower or the temperature of the heating element with respect to the angle of deflection of the deflector.

14. The controller of claim 10, further comprising:
a light control module configured to control a light, wherein the light is configured to emit a first color and a second color, the first color being different than the second color, wherein the light control module controls the light to emit the first color when the temperature of the heating element is a first temperature, and the second color when the temperature of the heating element is a second temperature, the first temperature being different than the second temperature.

15. A free standing, upright drier comprising:
a first unit, the first unit having a base portion and an end portion, the base portion being wider than the end portion, the base portion having a first edge and a second edge opposite the first edge, the first unit configured to increase in width from the end portion along a length of the first unit to the base portion;
a second unit, the second unit defining a passage between a first end of the second unit and a second end of the second unit, the second end being opposite the first end, the first end of the second unit having a width substantially identical to a width of the end portion of the first unit, the first end of the second unit being coupled to the end portion of the first unit;
a third unit, the third unit having a first end and a second end, the second end being opposite the first end, the first end of the third unit having a width substantially identical to a width of the second end of the second unit, the first end of the third unit being coupled to the second end of the second unit;
a support member disposed on a portion of the first unit, a portion of the second unit and a portion of the third unit, the support member configured to provide rigidity to the second unit, the support member further configured to join the first unit and the second unit, and the support member further configured to join the second unit and the third unit;
a first and a second foot member, the first and second foot members being disposed on the first edge and the second edge of the base portion, respectively;
the base portion defining an intake vent;
the second end of the third unit defining an outlet vent, the outlet vent including a deflector;
a blower disposed in the first unit, the blower configured to propel a fluid from the intake vent and discharge the fluid at the end portion of the first unit;
a heater disposed in the second unit, the heater configured to heat the fluid that enters the first end of the second unit and traverses a portion of a length of the second unit before the fluid is discharged at the second end of the second unit;
a light disposed on the first unit, the light configured to illuminate a portion of the base portion if the upright drier is connected to a power source;
a heater control disposed on the first unit, the heater control including a first setting and a second setting;
a blower control disposed on the first unit, the blower control including a first setting and a second setting;
a user control disposed at the base portion of the first unit, the user control configured to activate the blower and the heater based on a setting of the blower control and a setting of the heater control, respectively;
the user control including a timer configured to deactivate the blower and the heater after a length of time;
a safety switch disposed in the first unit, the safety switch configured to interrupt a power to at least one of the upright drier, the heater and the blower if a tilt angle of the upright drier exceeds a threshold value; and
a cancel switch disposed on the second unit, the cancel switch configured to deactivate the blower and the heater when selected.

16. The drier of claim 14, wherein a sum of a length of the first unit, a length of the second unit and a length of the third unit is less than twenty-four (24) inches.

17. The drier of claim 15, wherein an angle of the deflector is forty-five (45) degrees relative to an axis running a length of the drier.

18. A controller for controlling a drier having a blower a heating element and a deflector, the controller comprising:
a blower controller for controlling a blowing speed of the blower;
a heater controller for controlling a temperature of the heating element; and
a deflector controller for controlling an angle of deflection of the deflector, the blower controller and the heater controller being configured to vary one of the blowing speed and the temperature, respectively, based on the angle of deflection of the deflector.

19. The controller of claim 17, further comprising:
a light controller for controlling a lighting element, wherein the light controller varies at least one of a brightness and a color of the lighting element based on one of the blowing speed, the temperature of the heating element and the angle of deflection of the deflector.
